(19) United States
(12) Patent Application Publication
(10) Pub. No.: US 2008/0281807 A1
(43) Pub. Date: Nov. 13, 2008

(54) SEARCH ENGINE

(75) Inventors: Udo BARTLANG, Rosstal (DE); Alan Southall, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/758,377

(22) Filed: Jun. 5, 2007

(30) Foreign Application Priority Data
May 11, 2007 (EP) EP07009524

(51) Int. Cl. G06F 7/06; G06F 17/30

(52) U.S. Cl. 707/5; 707/101; 707/E17.008; 707/E17.014; 707/E17.053

(57) ABSTRACT

A search engine comprising search indices for entities, wherein a tag reputation of a tag which classifies an entity is updated by said search engine depending on a rating input by said user and depending on a user reputation of said user.

### BACKGROUND OF THE INVENTION

Information retrieval comprises the searching for information in documents, searching for documents themselves, searching for metadata which describe documents, as well as searching within data bases. Data bases may comprise stand-alone databases or hyper-text network databases such as the World Wide Web.

A search engine has an information retrieval system designed to help to find information stored in a computer system such as the World Wide Web or inside a proprietary network or within a personal computer of a user. Such a search engine allows a user to seek for content meeting specific criteria which are formed usually by keyphrases. A search engine retrieves a list of items that match those input criteria. This list is often sorted according to some measure of relevance. A search engine can be formed by a web search engine which searches for information on the public World Wide Web. Other kinds of search engines can be formed by enterprise search engines which search in intranets of companies. Well-known search engines are for instance “google” or “MSN-search” of Microsoft.

Conventional search engines use a search index which takes into account links from one document to other documents to assign a relevance of a document for a key phrase. A disadvantage of conventional search engines is that they do not integrate the users into the search. In most search engines the user has no influence as to the search process which is performed automatically by the search engine. There is no pro-active feedback by the user to influence the quantity and/or the quality of the search results. Accordingly, it often happens that search results even when listed according to a relevance do not meet the expectation of the user, i.e. the listed document are not the desired documents or documents of poor quality.

Another disadvantage of conventional search engines is that the ranking of the listed documents can be manipulated by so-called spam-pages, i.e. documents which are linked with other documents to influence the ranking performed by the search engine.

Accordingly, it is an object of the present invention to provide a search engine which supplies to the users with more relevant documents.

### SUMMARY OF THE INVENTION

The invention provides a search engine comprising search indices for entities, wherein the reputation of a tag, the so called tag reputation, which classifies an entity, is updated by said searching machine depending on a rating input by said user and depending on a user reputation of said user.

In an embodiment of the search engine according to the present invention the entity is a network (data) entity of a data network, e.g. a web page.

In an embodiment of the search engine according to the present invention a network is formed by a set of interconnected computers, ranging from local area networks (LANs) to wide area networks (WANs).

In a further embodiment of the search engine according to the present invention the data network is formed by the internet.

In an embodiment of the search engine according to the present invention said entity is formed by a web page.

In an embodiment of the search engine according to the present invention the entity is formed by a web service.

In an embodiment of the search engine according to the present invention each entity comprises a uniform resource identifier.

In an embodiment of the search engine according to the present invention the search engine is formed by a server of a service provider connected to a network.

In an embodiment of the search engine according to the present invention the search engine comprises a memory for storing a search index list comprising for a plurality of tags corresponding uniform resource identifiers of network entities classified by the respective tags.

In an embodiment of the search engine according to the present invention the tag is formed by a key phrase or a meta tag.

In an embodiment of the search engine according to the present invention the search engine comprises a memory for storing a user reputation index list comprising for a plurality of user IDs of users corresponding user reputations of the respective users, the so called user reputations.

In an embodiment of the search engine according to the present invention the search engine comprises a memory for storing a tag reputation index list comprising for a plurality of tags corresponding (tag) reputations of the respective tags.

In an embodiment of the search engine according to the present invention the search engine is connected via network to user clients.

In an embodiment of the search engine according to the present invention a search index update message is generated by an authorised user client and transmitted via a network-interface of said network to said search engine.

In an embodiment of the search engine according to the present invention the search index update message comprises a user ID of said user,

a rating for an entity and a uniform resource identifier of the entity.

In an embodiment of the search engine according to the present invention the search index update message further comprises

at least one tag for classifying the entity,
an optional comment of the user with respect to another comment input by another user with respect to that entity or input by another user with respect to the entity and a comment reference for the respective comment.

In an embodiment of the search engine according to the present invention the search engine comprises a memory for storing for each entity a corresponding comment index list which comprises a plurality of user IDs of users and comments input by said users for the respective entities.

In an embodiment of the search engine according to the present invention the search engine after receiving a search index update message from a client performs an update of said search index list by inserting tags of said search index update message into said search index list along with a uniform resource identifier of said search index update message.

In an embodiment of the search engine according to the present invention an update of the user reputation of a first user having a comment for an entity stored in said comment index list of said entity is performed after reception of a search index update message from a second user by said search engine depending on a user reputation of said second user and depending on the rating given by said second user in said search index update message, wherein the updated user reputation of said first user is stored by said search engine in a user reputation index list.

In an embodiment of the search engine according to the present invention a rating is given by said second user with respect to comments of said first user for said entity.

In an embodiment of the search engine according to the present invention the search engine performs an update of a tag reputation of all tags within a received search index update message depending on the user reputation of the respective user and stores the updated tag reputations in the tag reputation index list of the respective entity.

In an embodiment of the search engine according to the present invention the search engine performs an update of said comment index list of said entity by storing the comments of the last search index update message of said user with respect to said entity.

The invention further provides a method for indexing entities,

wherein a tag reputation of a tag which classifies an entity is updated depending on a user reputation of a user and depending on a rating input by said user.

The invention further provides a system for indexing entities,

wherein a tag reputation of a tag which classifies an entity is updated depending on a user reputation of a user and depending on a rating input by said user.

The invention further provides a client for providing a search index update message for a search engine connected to said client via a network,

wherein said search index update message comprises:
a user ID of a user,
a rating input by said user for an entity,
a uniform resource identifier of said entity,
at least one tag for classifying said entity,
and an optional comment of a user with respect to said entity or with respect to a comment of another user for said entity, wherein a tag reputation of said tag is updated depending on a user reputation of said user and depending on said rating input by said user.

### BRIEF DESCRIPTION OF THE ENCLOSED FIGURES

FIG. 1 is a block diagram for illustrating a possible embodiment of the system for indexing entities according to the present invention;

FIG. 2 is a signal diagram for illustrating a possible embodiment of the system according to the present invention;

FIG. 3 is a flow chart of a possible embodiment of a method for indexing entities according to the present invention;

FIG. 4 shows a data format of a search index update message according to a possible embodiment of the method according to the present invention;

FIG. 5 shows a further flow chart for illustrating an index update within a server of a possible embodiment of the system according to the present invention;

FIGS. 6A, 6B show an exemplary embodiments of a search index list as employed in an embodiment according to the present invention;

FIGS. 7A, 7B show exemplary embodiments of a user reputation index list as employed by a system according to the present invention;

FIGS. 8A, 8B show exemplary embodiments of a comment index list used in a system according to the present invention;

FIGS. 9A, 9B show exemplary embodiments of a tag reputation index list as used as a system according to the present invention;

FIG. 10 shows a flow chart of a normal search operation according to a possible embodiment of the search engine according to the present invention;

FIG. 11 shows an exemplary display of a tag rating to a client according to a possible embodiment of the present invention;

FIG. 12 shows an example of a sequence of user inputs performed in a system according to the present invention;

FIG. 13 shows a further example of user inputs according to a possible embodiment of the system according to the present invention.

### DETAILED DESCRIPTION OF THE FIGURES

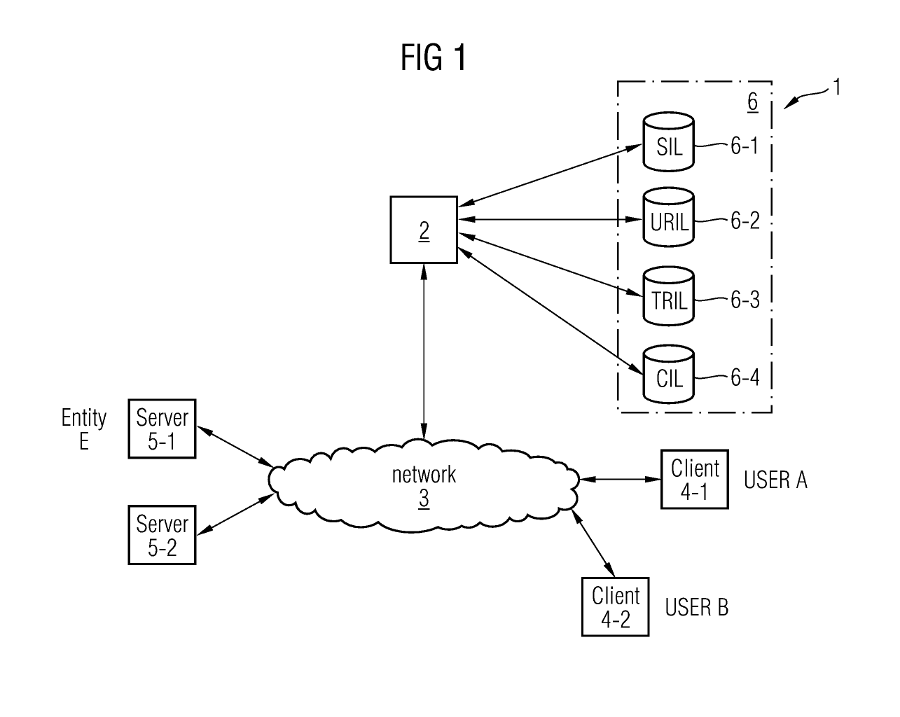

FIG. 1 shows a possible embodiment of a system 1 according to the present invention for indexing entities. An entity can be formed by any kind of document stored in any kind of memory or in any kind of database. The document can be linked to other documents for instance by hyper-links. The entity can be formed by a website page and/or by a general web service. The entity can comprise any sort of data such as text data or multimedia data.

As can be seen from FIG. 1, the system 1 comprises at least one search engine 2 connected to a network 3. The search engine 2 can be formed by a server. The network 3 can be any kind of data network such as a local network or a group of interlinked networks such as the internet. A plurality of client computers 4-1,4-2 and a plurality of servers 5-1,5-2 are connected to the network 3.

In the embodiment shown in FIG. 1 the system 1 comprises a search engine 2 connected to a database 6 storing a search index list (SIL) in a memory 6-1, a user reputation index list (URIL) in a memory 6-2, a tag reputation index list (TRIL) in a memory 6-3 and a comment index list (CIL) in a memory 6-4.

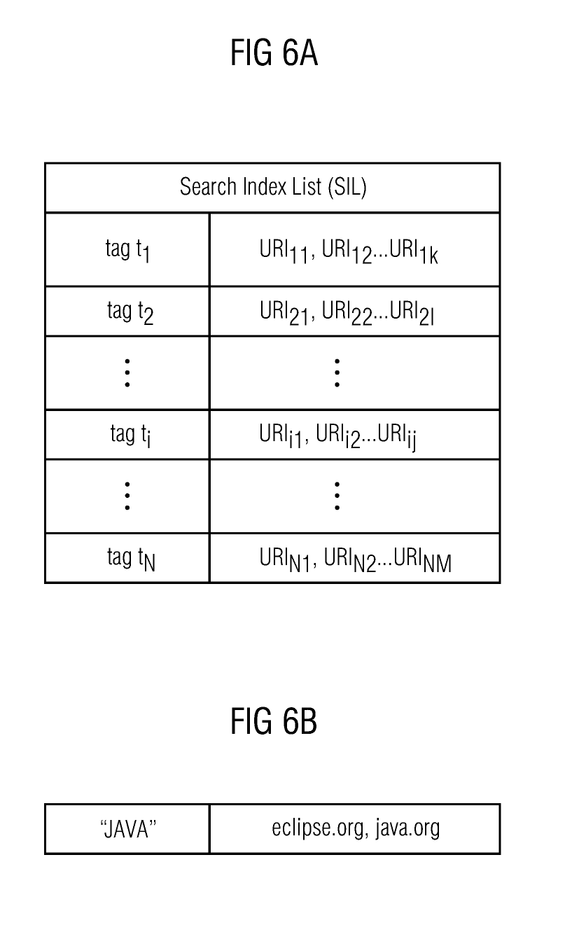

The search index list SIL comprises for a plurality of tags t corresponding uniform resource identifiers (URI) for network entities classified by the respective tags t. FIGS. 6A, 6B show an exemplary embodiment of a search index list SIL stored in the memory 6-1 of the database 6.

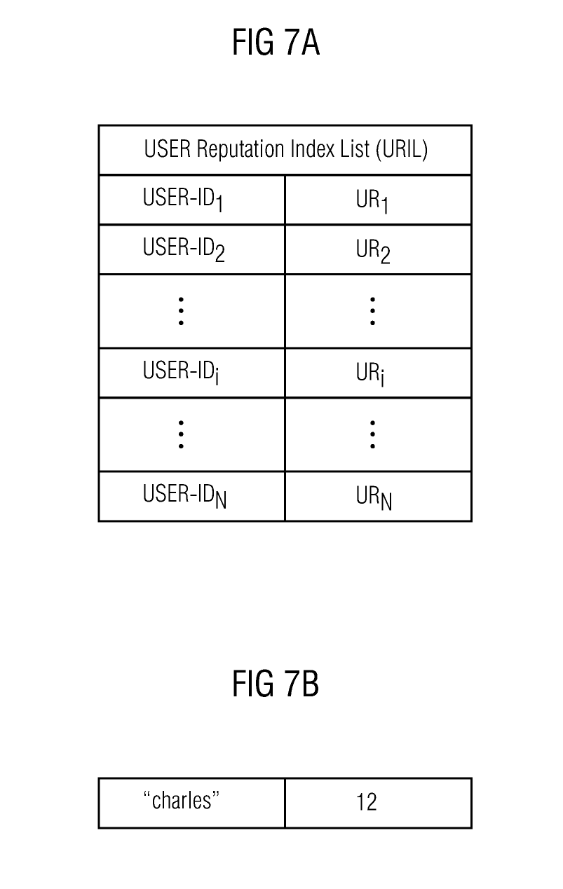

The user reputation index list URIL as stored in the memory 6-2 of the database 6 comprises for a plurality of user IDs of users corresponding user reputations UR of the respective users. FIGS. 7A, 7B show an exemplary embodiment of a user reputation index list URIL for different users.

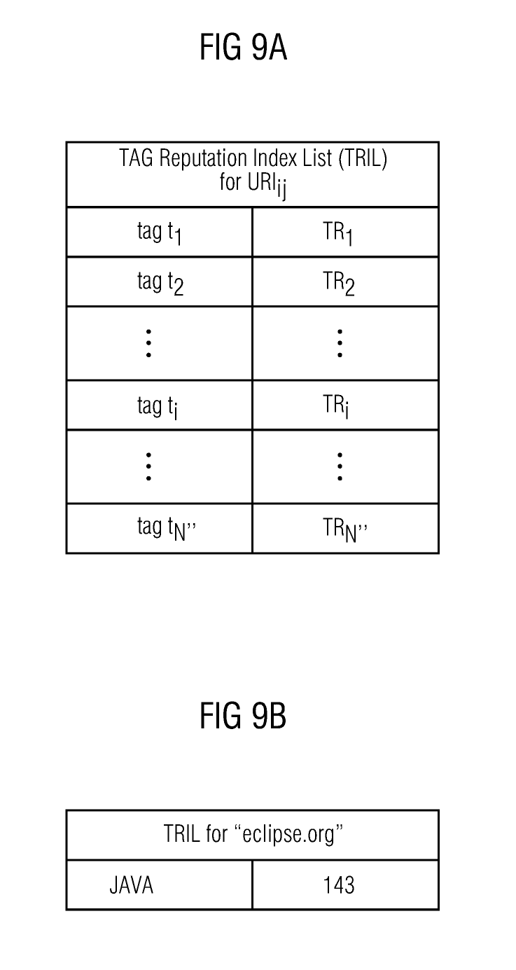

The tag reputation index list TRIL as stored in the memory 6-3 of the database 6 comprises for a plurality of tags t corresponding tag reputations TR. FIGS. 9A, 9B show an exemplary embodiment of a tag reputation index list TRIL stored in the memory 6-3.

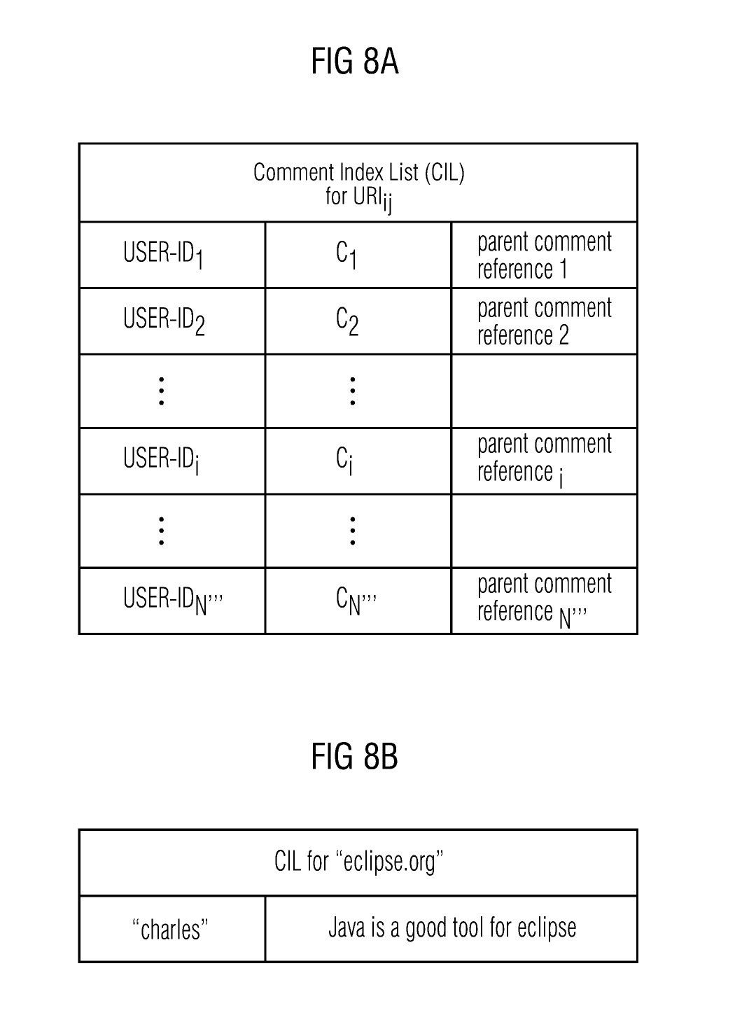

A comment index list CIL as stored in the memory 6-4 comprises a plurality of user IDs of users and comments C input by that users for the respective entities. FIGS. 8A, 8B show an exemplary embodiment of a comment index list CIL which is stored in the memory 6-4.

Each user, such as user A, user B in FIG. 1 can input via its client computer 4-1, 4-2 a rating R for an entity or a rating for a comment given by another user for said entity. The tag reputation TR of a tag t which classifies an entity is updated by the search engine depending on the ratings R input by the user and depending on a user reputation UR of the user. The tag reputation TR of a tag t is stored in the tag reputation index list TRIL as shown in FIGS. 9A, 9B. The user reputation of a user is stored in a user reputation index list URIL as shown in FIGS. 7A, 7B.

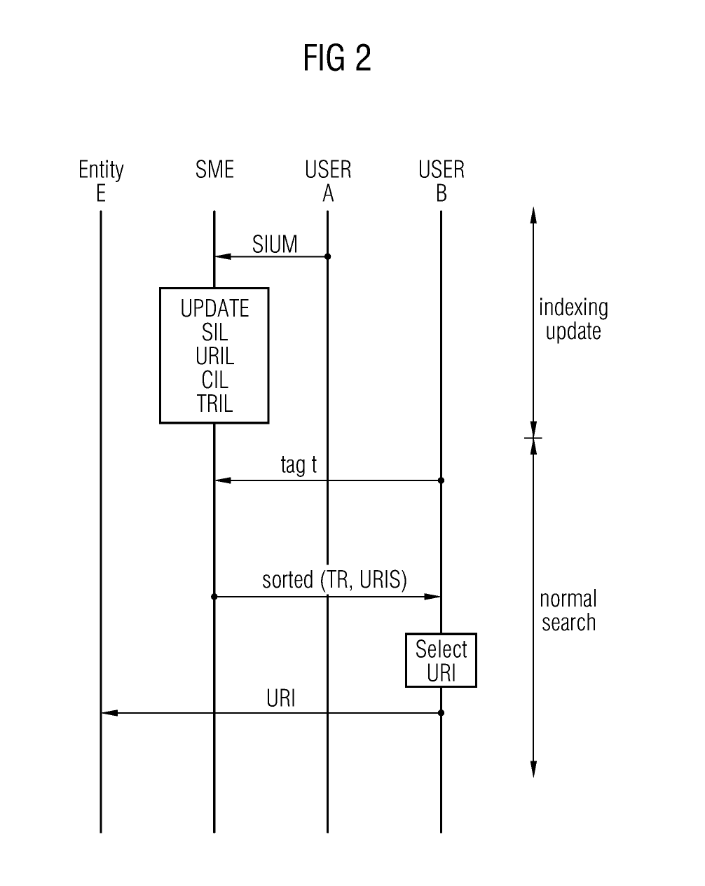

FIG. 2 shows a signal diagram illustrating a functionality of a search engine 2 according to the present invention. The user A sends a search index update message (SIUM) to the search engine 2 via the network 3. When the search engine 2 receives the search index update message SIUM it performs an update of the database 6, i.e. an update of the search index list SIL, an update of the user reputation index list URIL, an update of the tag reputation index list TRIL and an update of the comment index list CIL. Accordingly, in the example shown in FIG. 2 a user A wishes to perform an indexing update by sending a search index update message SIUM to the search engine 2.

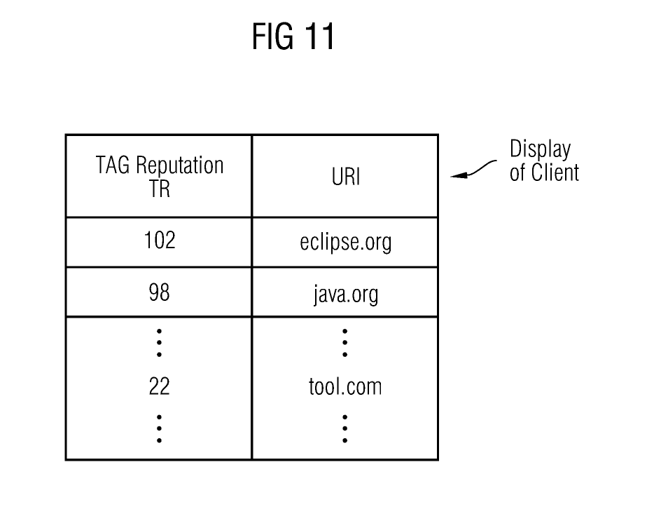

After that another user, i.e. user B performs a normal search by supplying a tag t which classifies an entity to the search engine 2. The search engine 2 performs a search and provides user B with a sorted list of URIs for the corresponding tag respecting a tag ratings TRs of the respective entities such as shown for example in FIG. 11.

In a further step user B can select a uniform resource identifier URI of an entity to get access to this entity E. The entity E can be any kind of document such as a web page or a webservice. A web page can be provided, for instance, by a server 5 as shown in FIG. 1. The uniform resource identifier URI is unique for the respective entity.

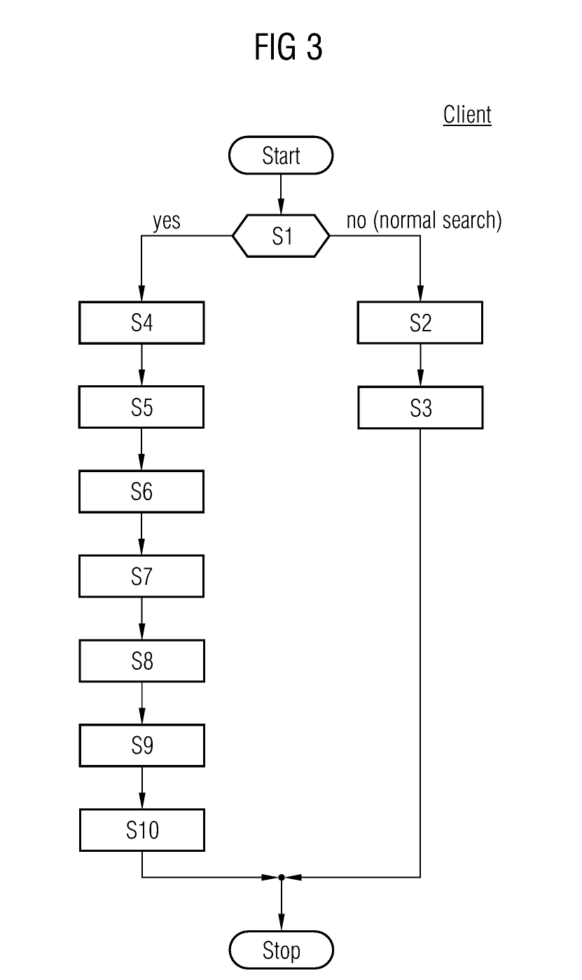

FIG. 3 shows a flow chart of a possible embodiment of a search operation performed by a client 4 as shown in FIG. 1.

After starting the search operation the user can decide in step S1 whether he wishes to perform an indexing operation or a normal search operation. When the user decides to perform a normal search he inputs tags t in a step S2 and transmits the tags t in a further step S3 to the search engine 2. The tags t can be formed by key words or keyphrases classifying the respective entity. If the user decides to perform an indexing update he performs a user log-in in step S4 to authenticate himself for the search engine 2.

In a further step S5 the user selects an entity such as “eclipse.org” and can view in a further step S6 all comments given by other users with respect to the entity. Possible comments might be, for instance: “eclipse.org is a good tool”

In a further step S7 the user can input further tags or key phrases for the respective entity such as “C++”.

Furthermore, the user can input in a further step S8 his own comment C for the entity, for example a comment for the entity “eclipse.org”, but also a comment to the comments given by the other users. In a further step S9 a search index update message SIUM is generated automatically by the client computer 4 and transmitted in step S10 to the search engine 2.

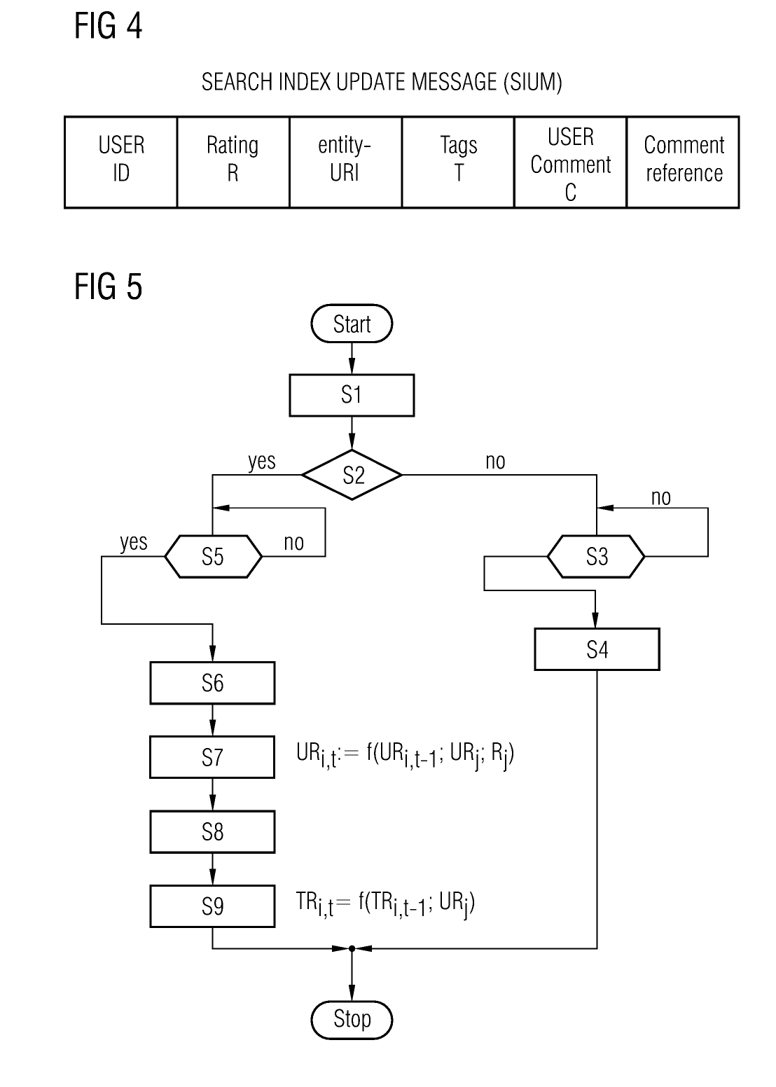

FIG. 4 shows a possible embodiment of a data format of a search index update message SIUM generated by a client computer 4 for transmission to the search engine 2. The search index update message SIUM is generated by the authorised client 4 and transmitted via a network interface to the search engine 2. The search index update message SIUM, as shown in FIG. 4, comprises a user ID of a user, a rating R and a uniform resource identifier URI of an entity.

In a further possible embodiment the search index update message SIUM further comprises at least one tag t for classifying the entity, a comment C of a user with respect to another (user) comment C′ input by another user or directly with respect to the entity. The rating R of the search index update message SIUM indicates, for example the quality of the referenced entity. The tags t are, for instance keywords or keyphrases to classify the referenced entity. The classification of the entities is built up dynamically. The user comment C and the comment reference is optional.

FIG. 5 shows a flow chart of a possible embodiment of an index update process within search engine 2.

After a call of the search engine 2 by a user via the network 3 in a step 1 the user informs the search engine 2 in step S2 whether he wishes to perform an indexing update or whether he wishes a normal search operation.

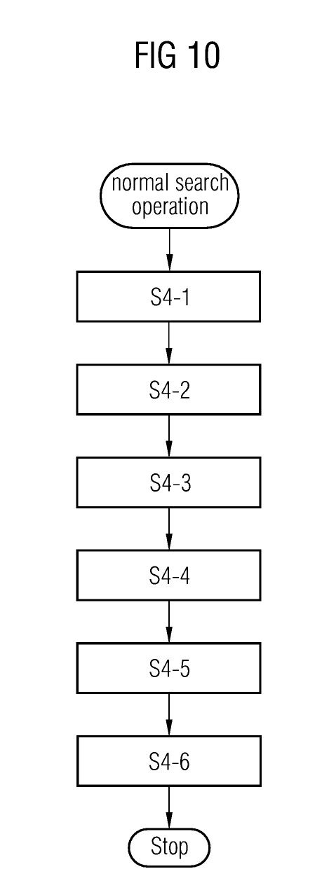

In case of a normal search operation the search engine 2 waits for tags t input by the user in step S3. Then, the search engine 2 performs a normal search operation on basis of the input tags t in step S4. The normal search operation is shown in more detail in FIG. 10.

In a first step S4-1 the search engine 2 gets tags tᵢ received from the searching user.

Then the search engine looks up all uniform resource identifiers stored in the search index list SIL for the input tags tᵢ in step S4-2. FIG. 6A shows an exemplary embodiment of the search index list SIL. FIG. 6B shows an example entry within such a search index list SIL. In the given example of FIG. 6B there are two uniform resource identifiers URI for tag “JAVA”, i.e. “eclipse.org” and “java.org”. For each uniform resource identifier URI for a tag tᵢ the search engine 2 looks up in the corresponding tag reputation index list TRIL all tag reputations TR in step S4-3. Then in step S4-4 the tag reputations TR of the tags t are sorted in step S4-4. In a further step S4-5 the sorted tag ratings TR are displayed to the user along with the uniform resource identifiers URIs. An example of displayed sorted tag ratings TR is shown in FIG. 11. In step S4-6 the user can select one listed uniform resource identifier URI to access to the respective network entity, for example by a mouse click.

As can be seen from FIG. 5 if the search engine 2 realizes in step S2 that the user does not want to perform a normal search operation but an indexing update search engine 2 waits in step S5 until it has received a search index update message SIUM from the user. After having received at least one search index update messages SIUM from the user having, for example the data format as shown in FIG. 4 the search engine 2 performs in step S6 an update of the search index list SIL as shown in FIGS. 6A, 6B. After the reception of the search index update message SIUM from the client 4 an update of the search index list SIL is performed by inserting tags t of the search index update message which are not already stored in the search index list SIL. The tags t are stored in the search index list SIL along with the uniform resource identifier contained in the search index update message SIUM as shown in FIG. 4.

In a further step S7 the search engine 2 updates the user reputation index list URIL as shown in FIGS. 7A, 7B. The user reputation UR of a user in the list is updated depending on the momentary user reputation URᵢ of said user and depending on the user reputation URⱼ of the user which has sent the search index update message SIUM and the rating Rⱼ given by this other user. The update of the user reputation UR of a first user URᵢ is performed when the first user (user IDᵢ has given a comment Cᵢ for an entity stored in the comment index list CIL and if a second user (user-IDⱼ) sends a search index update message SIUM giving a rating R for the comment Cᵢ of the first user (user-IDᵢ) with respect to the entity. The user reputation URᵢ of the first user is updated as a function of the rating Rⱼ given by the other user (user-IDⱼ) and depending on the user reputation URⱼ of the other user. The updated user reputation URᵢ′ is then stored in the user reputation index list URIL. In a further step S8 the search engine 2 performs an update of the comment index list CIL of the respective entity indicated by the uniform resource identifier URI by storing the comments C included in the received search index update message SIUM with respect to the entity. As shown in FIGS. 8A, 8B the comment C of a user for an entity such as the network entity “eclipse.org” is stored in the comment index list CIL, for example, a comment input by the user “Charles” for the entity “eclipse.org” might be “Java is a good tool for eclipse”.

In a further step S9, the search engine 2 performs an update of the tag reputation index list TRIL as shown in FIGS. 9A, 9B. The tag reputation TR of a tag t is updated depending on the actual tag reputation TR for this tag t and the user reputation UR of the user sending the search index update message SIUM. The search engine 2 performs an update of a tag reputation TR of all tags t within a received search index update message SIUM. An update of the tag reputation TR is performed depending on the user reputation UR of the user who sends the search index update message SIUM. Updated tag reputations TR are stored in the tag reputation index list TRIL of the respective entity.

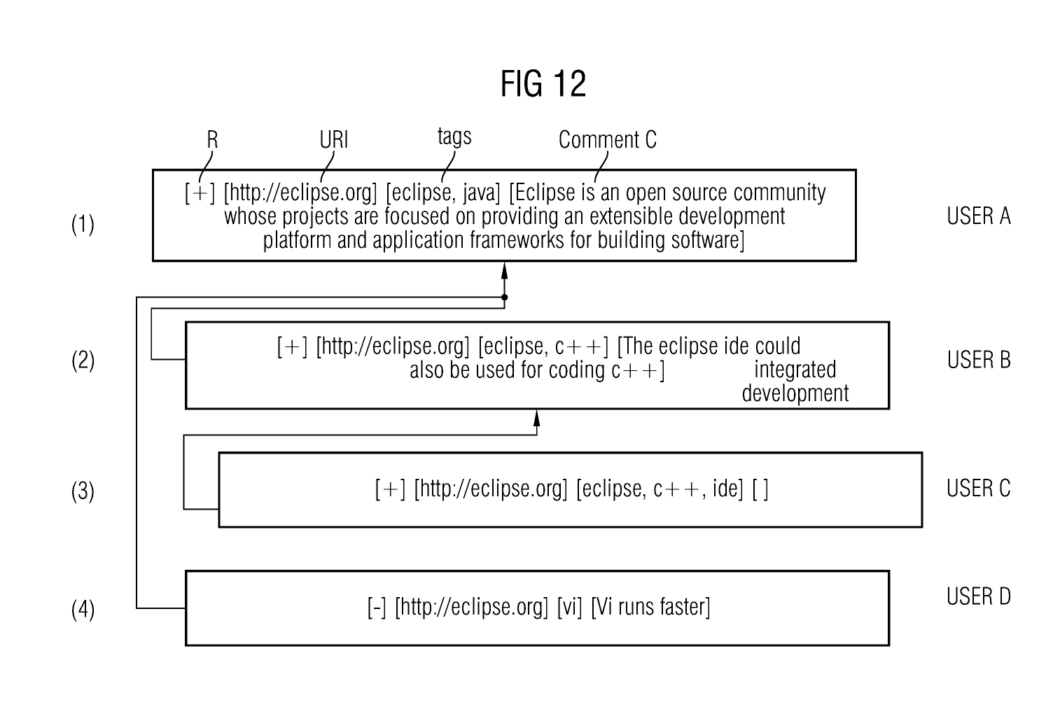

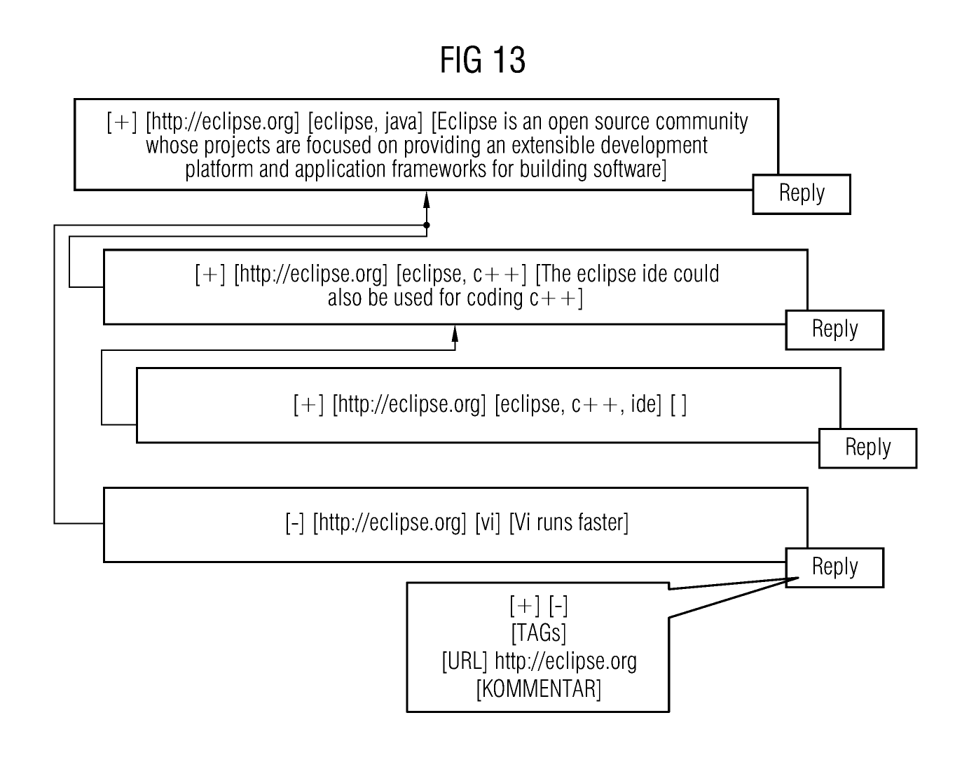

FIG. 12 shows an example of a user inputs for the search engine 2. In a first input a user A sends a search index update message SIUM which inserts a data set initially to the index of the search engine. The external referenced website, i.e. “http://eclipse.org” is rated positively by the user (+). The entity indicated by the resource identifier (eclipse.org) is provided with tags t, i.e. keywords or keyphrases by the user. In the given example shown in FIG. 12 the tags t given for the entity “eclipse.org” are “eclipse” and “java”. Further the user A inputs an optional comment C which is in the given example “eclipse is an open source community whose projects are focused on providing an extensible development platform and application frameworks for building software”. The input uniform resource identifier such as an URL forms a unique identifier to the entry and the tags t form additional searching aids. Depending on the user reputation UR of the user A a tag reputation TR for the input tags “eclipse” and “java” is assigned. If the user reputation UR of the user A is high the tag reputation TR of the tags t input by such a user are also higher than the tag reputation TR of other tags input by other users having a lower user reputation UR.

In the example shown in FIG. 12 another user B inputs a further search index update message SIUM rating the entity “eclipse.org” “high” (R=+) and inputting also tags t such as “eclipse” and “C++”. In a possible embodiment the rating of the tag “eclipse” is increased because both users A, B have input the same tag t or keyphrase for the entity “eclipse.org”. Furthermore, both users A, B have input the tag “eclipse” as the first tag t within a sequence of tags t. Since both users A, B rate the entity “eclipse.org” positively the tag reputation TR of the input tags t is increased. Furthermore, the user reputation UR of user A is also increased because the second user B has given the same positive rating as user A with respect to the entity “eclipse.org”. Accordingly, the system according to the present invention allows the user to work together on an index of the search engine 2. Furthermore, users having a high user reputation UR can influence the tag rating TR of tags t more than other users with a lower user reputation UR.

As can be seen from FIG. 12 a further user C inputs a search index update message SIUM for the entity “eclipse.org” with three keywords “eclipse”, “C++”, “IDE” and no comment C. In this example the user C also rates the entity positively (R=+), thus increasing the user reputation UR of user B.

User D inputs a search index update message wherein the rating given for the entity is negative (R=−). Accordingly, the reputation of the entry given by the user A and the user reputation UR of user A himself is diminished. Furthermore, a new tag “VI” is stored as a characterising feature of the entity “eclipse.org” as long as the user reputation UR of user D is positive. In a further embodiment of the method according to the present invention the user has not only the possibility to give comments C with respect to a network entity such as eclipse.org but also to give a comment C for a comment given by another user. For example, by clicking a reply button the user has the possibility to give a comment of his own to a comment of another user. An update of a user reputation UR of a first user which has given a comment C for an entity as stored in the comment index list CIL of said entity can be performed after reception of a search index update message SIUM of a second user depending on the user reputation UR of said second user and depending on the rating given by said second user in the search index update message SIUM. For example, if a second user having high user reputation UR, comments negatively on a comment of a first user the user reputation UR of the first user will be diminished significantly. In the same manner other users having a high user reputation commenting positively on a comment given by a first user can increase the user reputation UR of the first user.

In the method and system according to the present invention a quality of the search is increased significantly because each user has the opportunity to influence the tag reputation TR of a tag t which classifies a network entity. This tag reputation TR depends on the ratings R given by the users and depending on the user reputation UR of these users. Ratings of users with high user reputations UR have a strong impact on the tag reputation TR of a tag t. The reputation of a user i.e. is user reputation UR depends on the comments C he gives for the network entities. Furthermore, the user reputation UR of the user depends also on the comments C given by the other users with respect to the network entity or with respect to his comments. An authorised user known to the search engine 2 has the possibility to influence the index lists, thus increasing the quality of the search and increasing the search speed. These users have the ability to assign dynamically tags for specific uniform resource identifiers. The users further have the possibility to input comments C for referenced entities so that the users are motivated to read comments of other users. Furthermore, the method and system according to present invention allows to identify useless entries, i.e. SPAM and to eliminate such entries.

1. A search engine comprising:
search indices for entities, wherein a tag reputation of a tag which classifies an entity is updated by said search engine depending on a rating input by a user and depending on a user reputation of said user.

2. The search engine according to claim 1, wherein said entity is a network entity of a data network.

3. The search engine according to claim 2, wherein said data network is a local network.

4. The search engine according to claim 2, wherein the data network is formed by the Internet.

5. The search engine according to claim 4, wherein said entity is a web page.

6. The search engine according to claim 4, wherein said entity is a web service.

7. The search engine according to claim 1, wherein each entity comprises an uniform resource identifier.

8. The search engine according to claim 1, wherein said search engine is formed by a server of a service provider connected to a network.

9. The search engine according to claim 1, wherein said search engine comprises a memory for storing a search index list comprising for a plurality of tags corresponding uniform resource identifiers of network entities classified by the respective tags.

10. The search engine according to claim 9, wherein a tag is formed by a key phrase.

11. The search engine according to claim 1, wherein said search engine comprises a memory for storing a user reputation index list comprising for a plurality of user IDs of users corresponding user reputation values of the respective users.

12. The search engine according to claim 1, wherein said search engine comprises a memory for storing a tag reputation index list comprising for a plurality of tags corresponding tag reputation values of the respective tags.

13. The search engine according to claim 1, wherein said search engine is connected via a network to user clients.

14. The search engine according to claim 13, wherein a search index update message is generated by an authorized user client and transmitted via a network interface of said network to said search engine.

15. The search engine according to claim 14, wherein the search index update message comprises:
a user ID of said user,
a rating for an entity, and
a uniform resource identifier of said entity.

16. The search engine according to claim 15, wherein said search index update message further comprises:
at least one tag for classifying said entity,
a comment of said user with respect to another comment input by another user with respect to said entity or with respect to said entity, and
a comment reference for the respective comment.

17. The search engine according to claim 1, wherein said search engine comprises a memory for storing for each entity a corresponding comment index list which comprises a plurality of user IDs of users and comments input by said users for the respective entities and references to respective parent comments which are comments to which the input comments refer to.

18. The search engine according to claim 9, wherein the search engine after reception of a search index update message from a client performs an update of said search index list by inserting tags of said search index update message which are not already stored in said search index list into said search index list along with the uniform resource identifier of said search index update message.

19. The search engine according to claim 1,
wherein an update of a user reputation of a first user having a comment for an entity stored in said comment index list of said entity is performed after reception of a search index update message from a second user by said search engine depending on a user reputation of said second user and depending on the rating given by said second user in said search index update message,
wherein the updated user reputation of said first user is stored by said search engine in a user reputation index list.

20. The search engine according to claim 19, wherein said rating is given by said second user with respect to the comments of said first user for said entity.

21. The search engine according to claim 1, wherein said search engine performs an update of a tag reputation of all tags within a received search index update message depending on the user reputation of the respective user and stores the updated tag reputations of the tag reputation index list of the respective entity.

22. The search engine according to claim 1, wherein the search engine performs an update of said comment index list of said entity by storing the comment of the last search index update message of said user with respect to said entity.

23. A method for indexing entities, comprising:
updating a tag reputation of a tag which classifies an entity depending on a user reputation of a user and depending on a rating input by said user.

24. A system for indexing entities, comprising:
an update unit updating a tag reputation of a tag which classifies an entity depending on a user reputation of a user and depending on a rating input by said user.

25. A client for providing a search index update message for a search engine connected to said client via a network, comprising:
a processing unit programmed to generate a search index update message that includes a user ID of a user, a rating input by said user for an entity of said network, a uniform resource identifier of said entity, at least one tag for classifying said entity, and a comment of said user with respect to said entity or with respect to a comment of another user for said entity, the search engine updating a tag reputation of said tag depending on a user reputation of said user and depending on the rating of said search index update message.
